(19) United States
(12) Patent Application Publication
(10) Pub. No.: US 2025/0260148 A1
(43) Pub. Date: Aug. 14, 2025

(54) BATTERY CELL ELECTROLYTE WETTING SYSTEM AND METHOD

(71) Applicant: GM Global Technology Operations LLC, Detroit, MI (US)

(72) Inventor: Andrew Knesnik, Milford, PA (US)

(21) Appl. No.: 18/440,201

(22) Filed: Feb. 13, 2024

(51) Int. Cl. H01M 50/682; H01M 50/30; H01M 50/627

(52) U.S. Cl. CPC H01M 50/682; H01M 50/30; H01M 50/627

(57) ABSTRACT

A system includes a battery cell having a cell housing having at least a wall and a side wall, an electrolyte inlet opening formed on the wall, and an air hole formed on the side wall, and a sump including a sump housing configured to hold electrolyte therein. The electrolyte inlet opening is fluidly coupled to the sump housing to allow for the electrolyte to be fed from the sump housing into the cell housing.

### INTRODUCTION

The subject disclosure relates to vehicles, and in particular to a system and method for wetting a battery cell with electrolyte.

A vehicle battery cell may be wetted with electrolyte. Accordingly, it is desirable to provide an efficient system and method for filling the battery cell with the electrolyte.

### SUMMARY

In one exemplary embodiment, a system comprises a battery cell comprising a cell housing having at least a wall and a side wall, an electrolyte inlet opening formed on the wall, and an air hole formed on the side wall, and a sump comprising a sump housing configured to hold electrolyte therein. The electrolyte inlet opening is fluidly coupled to the sump housing to allow for the electrolyte to be fed from the sump housing into the cell housing.

In addition to one or more of the features described herein, the battery cell is oriented such that the side wall faces a direction opposite a gravitational direction.

In addition to one or more of the features described herein, the battery cell is oriented such that the wall faces a direction perpendicular to a gravitational direction.

In addition to one or more of the features described herein, the battery cell comprises a stack including a first electrode active material and a second electrode active material.

In addition to one or more of the features described herein, the stack comprises a wick formed at least in part by the first electrode active material and the second electrode active material.

In addition to one or more of the features described herein, the sump comprises a maximum fill line corresponding to an uppermost portion of the wick of the stack.

In addition to one or more of the features described herein, the first electrode active material is an anode active material, and the second electrode active material is a cathode active material.

In addition to one or more of the features described herein, the system further comprises a first electrode terminal disposed on the wall.

In addition to one or more of the features described herein, the stack further comprises a first electrode tab contacting the first electrode active material and electrically connected to the first electrode terminal via a first electrode connector.

In addition to one or more of the features described herein, the wall and the side wall face directions perpendicular to each other.

In another exemplary embodiment, a method for wetting a wick of a stack of a battery cell comprises forming an electrode inlet opening in a wall of a cell housing of the battery cell, forming an air hole in a side wall of the cell housing of the battery cell, fluidly coupling a sump to the electrode inlet opening, and feeding electrolyte from the sump into the cell housing via the electrode inlet opening.

In addition to one or more of the features described herein, the method further comprises orienting the battery cell such that the side wall faces a direction opposite a gravitational direction.

In addition to one or more of the features described herein, the method further comprises orienting the battery cell such that the wall faces a direction perpendicular to a gravitational direction.

In addition to one or more of the features described herein, the wick is formed at least in part by a first electrode active material and a second electrode active material.

In addition to one or more of the features described herein, the method further comprises filling a sump housing of the sump with electrolyte at or below a maximum fill line corresponding to an uppermost portion of the wick of the stack.

In addition to one or more of the features described herein, the first electrode active material is an anode active material and the second electrode active material is a cathode active material.

In addition to one or more of the features described herein, the wall and the side wall face directions perpendicular to each other.

In addition to one or more of the features described herein, the method further comprises stopping the feeding of the electrolyte into the cell housing when the wick is sufficiently wetted.

In addition to one or more of the features described herein, the method further comprises venting from the air hole air released from the wick when displaced by the electrolyte fed into the cell housing.

In yet another exemplary embodiment, a system comprises a battery cell comprising a cell housing having at least a wall and a side wall, the battery cell oriented such that the wall faces a lateral direction perpendicular to a gravitational direction and the side wall faces an upward direction opposite the gravitational direction, a stack disposed within the cell housing and comprising an anode active material, an anode tab, a cathode active material, and a cathode tab, a wick of the stack formed at least in part by the anode active material and the cathode active material, an electrolyte inlet opening formed on the wall, an air hole formed on the side wall, an anode terminal disposed on the wall that is electrically connected to the anode tab via an anode connector, and a cathode terminal disposed on the wall that is electrically connected to the cathode tab via a cathode connector, and a sump comprising a sump housing configured to hold electrolyte therein. The electrolyte inlet opening is fluidly coupled to the sump housing to allow for the electrolyte to be fed from the sump housing into the cell housing. The sump comprises a maximum fill line corresponding to an uppermost portion of the wick of the stack.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a left side view of a vehicle including an electric motor assembly according to one or more embodiments;

FIG. 2 is a perspective view of a battery cell according to one or more embodiments;

FIG. 3 is a stack of a battery cell according to one or more embodiments;

FIG. 4. is a perspective view of a battery cell according to one or more embodiments;

FIG. 5 is a cross-sectional view of the battery cell of FIG. 4 taken at line 5-5;

FIG. 6 is a cross-sectional view of the battery cell of FIG. 5 fluidly coupled to a sump according to one or more embodiments;

FIGS. 7A-7F are schematic views demonstrating an example wetting process of a wick of a stack of a battery cell according to one or more embodiments;

FIG. 8 is a perspective view of a battery cell according to one or more embodiments; and

FIG. 9 is a flow chart showing a process for wetting a wick of a stack of a battery cell according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

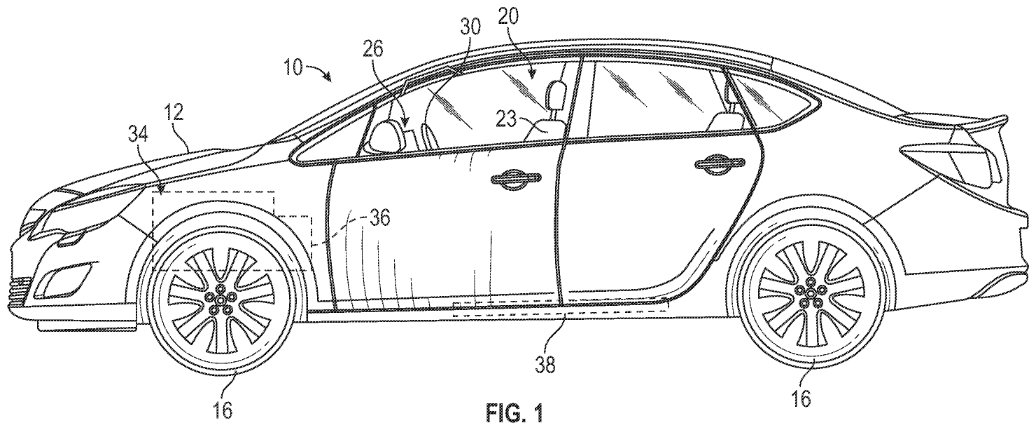

A vehicle 10 according to a non-limiting example is shown in FIG. 1. The vehicle 10 includes a body 12 supported on a plurality of wheels 16. One or more of the plurality of wheels 16 are steerable. The body 12 defines, in part, a passenger compartment 20 having seats 23 positioned behind a dashboard 26. A steering control 30 is arranged between seats 23 and a dashboard 26. The steering control 30 is operated to control orientation of the steerable wheel(s) 16.

The vehicle 10 includes an electric motor 34 connected to a transmission 36 that provides power to one or more of the plurality of wheels 16. A rechargeable energy storage system 38 is arranged in the body 12 and provides power to the electric motor 34. While specific locations are shown for the electric motor 34, the transmission 36, and the rechargeable energy storage system 38 in FIG. 1, these locations are merely exemplary and not limiting, and locations of these structures may vary.

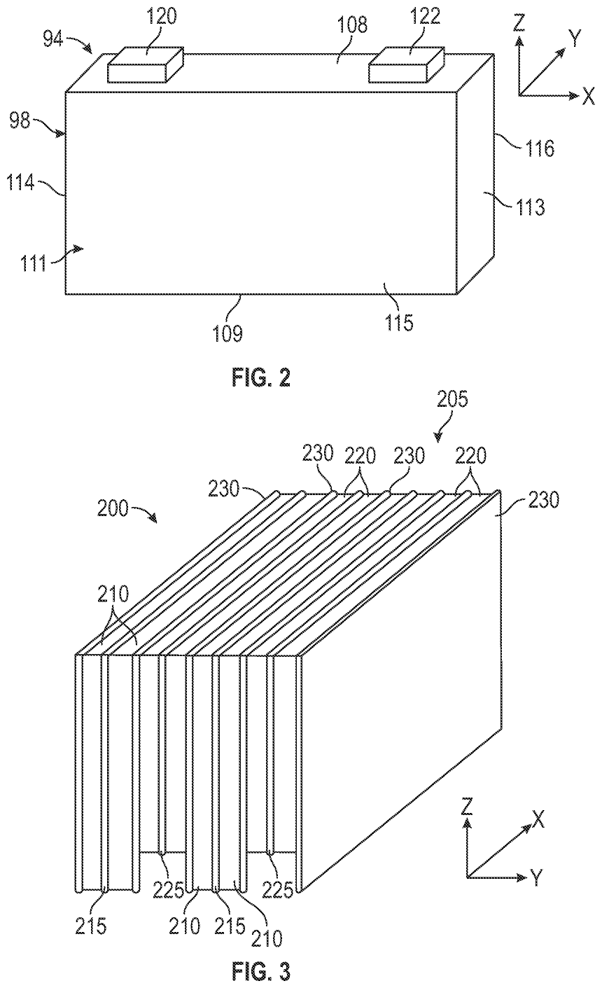

The rechargeable energy storage system 38 may include a plurality of battery cells 94, a non-limiting example of which is shown in FIG. 2. The battery cell 94 defines an X-axis, a Y-axis, and a Z-axis. The battery cell 94 may include a cell can 98. The cell can 98 may include a first wall 108, a second wall 109, and a plurality of side walls 111 that extend between and connect to first wall 108 and second wall 109. The plurality of side walls 111 may include a first side wall 113, a second side wall 114, a third side wall 115, and a fourth side wall 116. As shown in FIG. 2, the first wall 108 and the second wall 109 may be opposite each other along the Z-axis, the first side wall 113 and the second side wall 114 may be opposite each other along the X-axis, and the third side wall 115 and the fourth side wall 116 may be opposite each other along the Y-axis. The cell can 98 is an example of a cell housing.

The first wall 108 may support a first electrode terminal 120 which may be an anode terminal and a second electrode terminal 122 which may be a cathode terminal. While specific locations are shown for the first electrode terminal 120 and the second electrode terminal 122 in FIG. 2, these locations are merely exemplary and not limiting, and locations of these structures may vary. For example, the first electrode terminal 120 and second electrode terminal 122 may be on different walls.

FIG. 3 shows a stack 200 according to one or more embodiments. The stack 200 may be formed of a plurality of alternating layers including first electrode active materials 210, first electrode tabs 215 disposed between the first electrode active materials 210, second electrode active materials 220, second electrode tabs 225 disposed between the second electrode active materials 220, and separators 230 between the first electrode active materials 210 and the second electrode active materials 220 as well as on outer ends of the stack 200.

According to one or more embodiments, the first electrode active materials 210 may be anode active materials, the first electrode tabs 215 may be anode tabs, the second electrode active materials 220 may be cathode active materials, and the second electrode tabs 225 may be cathode tabs. According to one or more embodiments, the first electrode tab 215 may be a copper tab, and the second electrode tab 225 may be an aluminum tab.

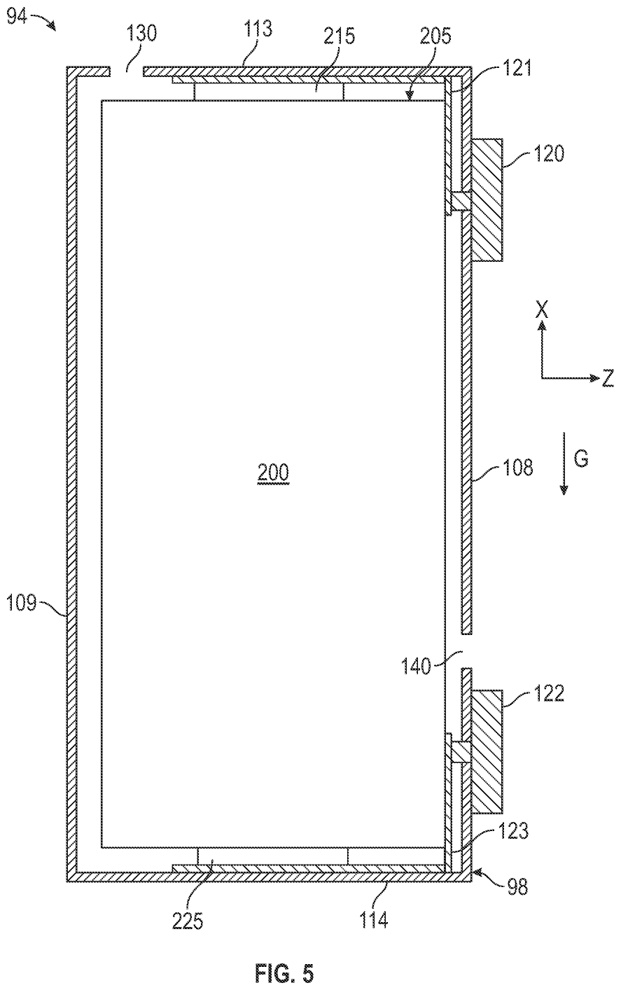

Permeable layers of the stack 200 may be referred to as wicks. The wicks may include, for example, the first electrode active materials 210, the second electrode active materials 220, and/or the separators 230. When forming the battery cell 94, the wicks of the stack 200 may be wetted by flowing electrolyte into the cell can 98. A system and method for wetting the wicks of the stack 200 will be described below with reference to FIGS. 5-8.

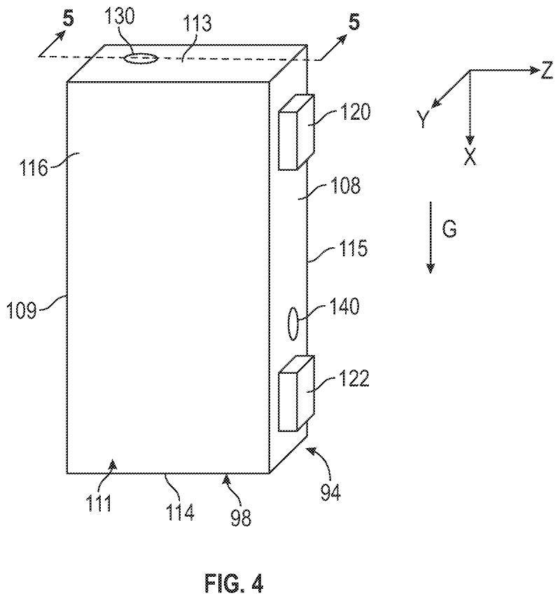

FIG. 4 shows a battery cell 94 according to one or more embodiments. The battery cell 94 shown in FIG. 4 is similar to that shown in FIG. 2, but further includes an air hole 130 formed on the first side wall 113 and an electrolyte inlet opening 140 formed on the first wall 108. The air hole 130 and/or the electrolyte inlet opening 140 may be formed by drilling into the first wall 108 and/or the first side wall 113. Alternatively, the first wall 108 and/or the first side wall 113 may be formed with the air hole 130 and/or the electrolyte inlet opening 140 pre-formed.

As shown in FIG. 4, the battery cell 94 may be oriented such that the air hole 130 faces in an upward direction, i.e., opposite a gravitational direction G. That is, the battery cell 94 may be oriented such that the gravitational direction G is parallel to the X-axis. The electrolyte inlet opening 140 may face a lateral direction, i.e., perpendicular to the gravitational direction G. That is, the battery cell 94 may be oriented such that the gravitational direction G is perpendicular to the Z-axis. Hereinbelow, the direction opposite the gravitational direction G will be defined as an upward direction, and the gravitational direction G will be defined as a downward direction.

FIG. 5 shows a cross-sectional view of the battery cell 94 taken at line 5-5 in FIG. 4. A first electrode connector 121 may be disposed in the cell can 98 that electrically connects the first electrode terminal 120 and the first electrode tab 215 of the stack 200. A second electrode connector 123 may be disposed in the cell can 98 that electrically connects the second electrode terminal 122 and the second electrode tab 225 of the stack 200. The first electrode connector 121 may be an anode connector, and the second electrode connector 123 may be a cathode connector.

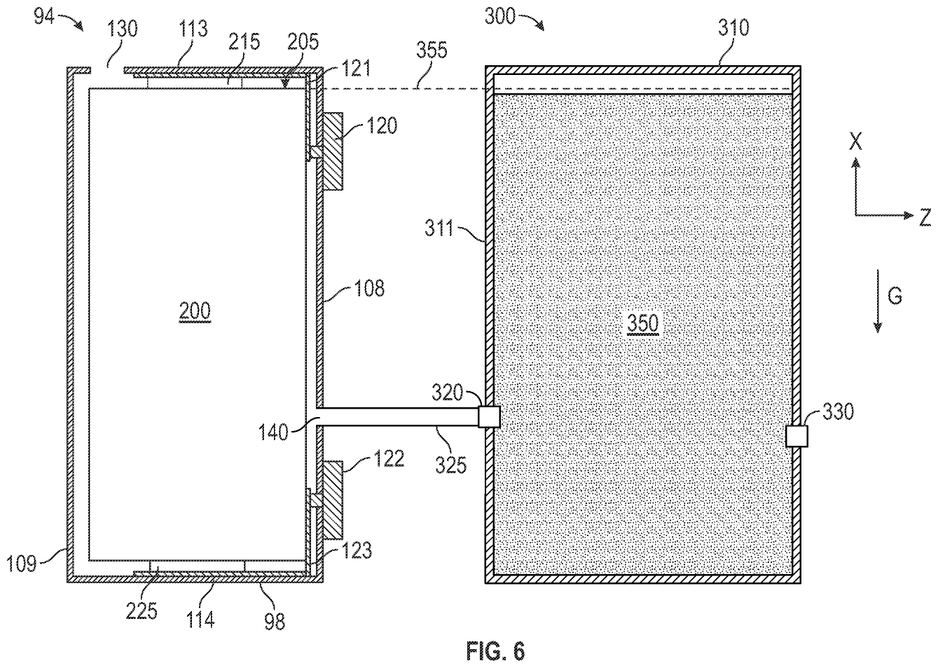

FIG. 6 shows the battery cell 94 connected to a sump 300 according to one or more embodiments. The sump 300 may include a sump housing 310 that is configured to hold an electrolyte pool 350. The sump housing 310 may be a cylindrical housing, a box-shaped housing, or any other structure known in the art for storing a fluid. An electrolyte conduit 325 may extend from the sump 300 and fluidly coupled to the electrolyte inlet opening 140. A first valve 320 may be formed on a side wall 311 of the sump housing 310 and may open to allow electrolyte to flow from the electrolyte pool 350 within the sump housing 310 of the sump 300 to an inside of the cell can 98 and close to shut off a flow of the electrolyte from the electrolyte pool 350 to the inside of the cell can 98. According to one or more embodiments, a second valve 330 may be formed on the sump housing 310 that may open to at least partially drain the sump 300.

The sump 300 may further a maximum fill line 355 that may correspond to an uppermost portion of the wick of the stack 200 in the orientation shown in FIG. 6. The electrolyte pool 350 may be filled just below the maximum fill line 355 to prevent overfilling the cell can 98. According to one or more embodiments, the electrolyte pool 350 may be filled at or below the maximum fill line 355. Because only the wick of the stack 200 is to be wetted, the maximum fill line 355 may correspond to the uppermost portion of the wick of the stack 200.

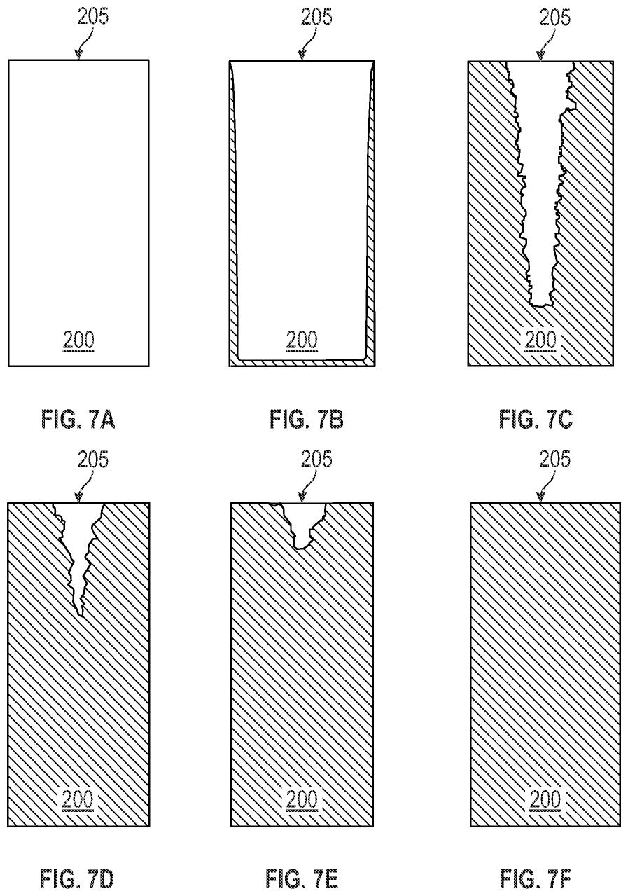

FIGS. 7A-7F show the wick of the stack 200 being wetted by electrolyte over time according to one or more embodiments. In FIG. 7A, the wick of the stack 200 is dry. As the electrolyte flows into the cell can 98 from the sump 300 through the electrolyte inlet opening 140, the electrolyte surrounds the wick of the stack 200 on lateral and bottom portions thereof, and as shown in FIG. 7B, the electrolyte begins to permeate the wick of the stack 200. Because the electrolyte pool 350 in the sump housing 310 of the sump 300 is filled just below the maximum fill line 355 that corresponds to the uppermost portion of the wick of the stack 200, the electrolyte does not fill the cell can 98 above the wick of the stack 200. As such, the electrolyte does not permeate the wick of the stack 200 from the upper direction. As the electrolyte progressively continues to permeate the wick of the stack 200 as shown in FIGS. 7C, 7D, and 7E, air within the wick of the stack 200 displaced by the electrolyte is pushed in the upward direction and exits the cell can 98 via the air hole 130. Once the wick of the stack 200 is fully wetted as shown in FIG. 7F, the electrolyte conduit 325 is decoupled from the electrolyte inlet opening 140 and/or the first valve 320 may be closed to shut off the supply of the electrolyte from the sump 300. According to one or more embodiments, after the wick of the stack 200 is wetted, for example, through the air hole 130 or the inlet opening 140.

As described above, the air within the wick of the stack 200 displaced by the electrolyte is pushed in the upward direction and exits the cell can 98 via the air hole 130. As such, the wick of the stack 200 may be wetted without formation of air bubbles within the wick of the stack 200. The inventors unexpectedly discovered that, when the electrolyte is fed into the cell can 98 from a wall disposed in the upward direction, the electrolyte may permeate the wick of the stack 200 from upward, downward, and side directions such that air bubbles may be trapped within the wick of the stack 200, slowing the wetting process. The inventors further unexpectedly discovered that filling the cell can 98 with electrolyte above the wick of the stack 200 may result the electrolyte permeating the wick of the stack 200 from upward, downward, and side directions such that air bubbles may be trapped within the wick of the stack 200, slowing the wetting process. One or more of the systems and methods described herein may thus improve efficiency of the wetting process of the wick of the stack 200 of the battery cell 94.

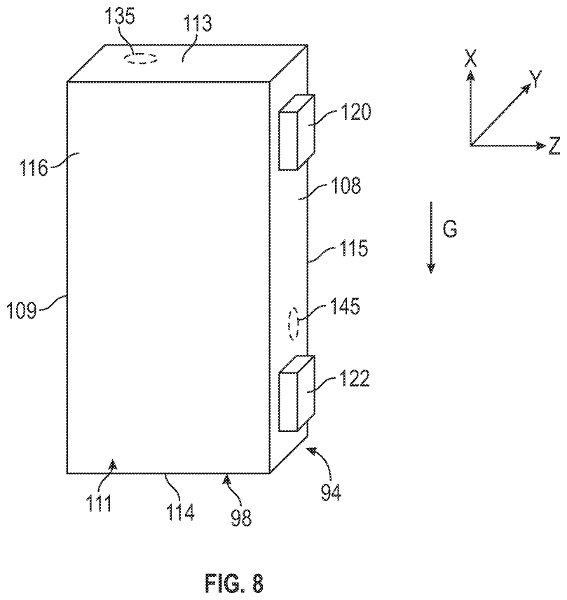

As shown in FIG. 8, once the wick of the stack 200 is fully wetted, the air hole 130 may be closed to form a first closed portion 135 and the electrolyte inlet opening 140 may be closed to form a second closed portion 145. The first closed portion 135 and the second closed portion 145 may be formed by welding or any structure or process known in the art for closing holes and/or openings.

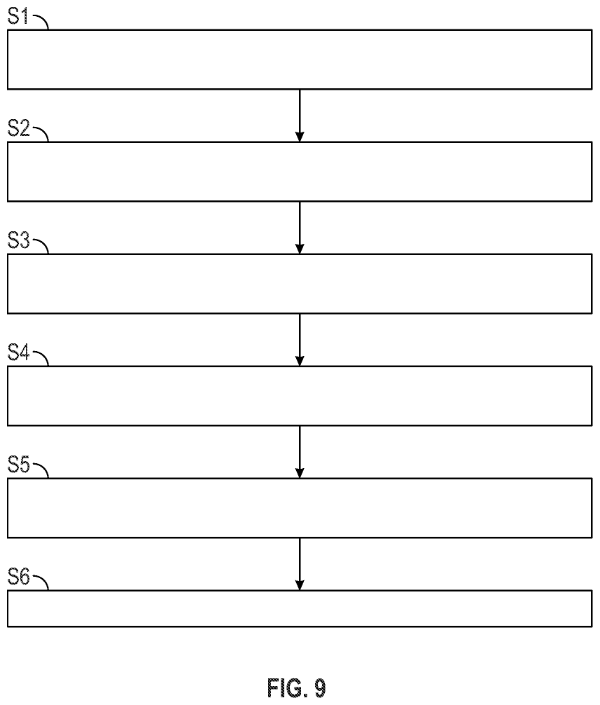

FIG. 9 shows a method for wetting the wick of a stack 200 of a battery cell 94 according to one or more embodiments. In Step S1, the electrolyte inlet opening 140 is formed in the first wall 108 and the air hole 130 is formed in the first side wall 113. In Step S2, the cell can 98 is oriented such that the air hole 130 faces an upward direction and the electrolyte inlet opening 140 faces a lateral direction. As described above, the upward direction may be opposite the gravitational direction G and the lateral direction may be perpendicular to the gravitational direction G. In Step S3, the sump 300 is fluidly connected to the electrolyte inlet opening 140 of the cell can 98. In Step S4, electrolyte is fed from the sump 300 into the cell can 98 through the electrolyte inlet opening 140 until the wick of the stack 200 is fully wetted. In Step S5, the electrolyte inlet opening 140 of the cell can 98 is disconnected from the sump 300. In step S6, the air hole 130 and the electrolyte inlet opening 140 are closed.

One or more embodiments of the systems and methods described above may be applied to various types of battery cells, including but not limited to pouch cells and cylindrical cells.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A system comprising:
a battery cell comprising:
a cell housing having at least a wall and a side wall,
an electrolyte inlet opening formed on the wall, and
an air hole formed on the side wall; and
a sump comprising a sump housing configured to hold electrolyte therein,
wherein the electrolyte inlet opening is fluidly coupled to the sump housing to allow for the electrolyte to be fed from the sump housing into the cell housing.

2. The system of claim 1, wherein the battery cell is oriented such that the side wall faces a direction opposite a gravitational direction.

3. The system of claim 1, wherein the battery cell is oriented such that the wall faces a direction perpendicular to a gravitational direction.

4. The system of claim 1, wherein the battery cell comprises a stack including a first electrode active material and a second electrode active material.

5. The system of claim 4, wherein the stack comprises a wick formed at least in part by the first electrode active material and the second electrode active material.

6. The system of claim 5, wherein the sump comprises a maximum fill line corresponding to an uppermost portion of the wick of the stack.

7. The system of claim 4, wherein the first electrode active material is an anode active material, and the second electrode active material is a cathode active material.

8. The system of claim 4, further comprising a first electrode terminal disposed on the wall.

9. The system of claim 8, wherein the stack further comprises a first electrode tab contacting the first electrode active material and electrically connected to the first electrode terminal via a first electrode connector.

10. The system of claim 1, wherein the wall and the side wall face directions perpendicular to each other.

11. A method for wetting a wick of a stack of a battery cell, comprising:
forming an electrode inlet opening in a wall of a cell housing of the battery cell;
forming an air hole in a side wall of the cell housing of the battery cell;
fluidly coupling a sump to the electrode inlet opening; and
feeding electrolyte from the sump into the cell housing via the electrode inlet opening.

12. The method of claim 11, further comprising orienting the battery cell such that the side wall faces a direction opposite a gravitational direction.

13. The method of claim 11, further comprising orienting the battery cell such that the wall faces a direction perpendicular to a gravitational direction.

14. The method of claim 11, wherein the wick is formed at least in part by a first electrode active material and a second electrode active material.

15. The method of claim 11, further comprising filling a sump housing of the sump with electrolyte at or below a maximum fill line corresponding to an uppermost portion of the wick of the stack.

16. The method of claim 14, wherein the first electrode active material is an anode active material and the second electrode active material is a cathode active material.

17. The method of claim 11, wherein the wall and the side wall face directions perpendicular to each other.

18. The method of claim 11, further comprising stopping the feeding of the electrolyte into the cell housing when the wick is sufficiently wetted.

19. The method of claim 11, further comprising venting from the air hole air released from the wick when displaced by the electrolyte fed into the cell housing.

20. A system comprising:
a battery cell comprising:
a cell housing having at least a wall and a side wall, the battery cell oriented such that the wall faces a lateral direction perpendicular to a gravitational direction and the side wall faces an upward direction opposite the gravitational direction,
a stack disposed within the cell housing and comprising an anode active material, an anode tab, a cathode active material, and a cathode tab, a wick of the stack formed at least in part by the anode active material and the cathode active material,
an electrolyte inlet opening formed on the wall,
an air hole formed on the side wall,
an anode terminal disposed on the wall that is electrically connected to the anode tab via an anode connector, and
a cathode terminal disposed on the wall that is electrically connected to the cathode tab via a cathode connector; and
a sump comprising a sump housing configured to hold electrolyte therein,
wherein the electrolyte inlet opening is fluidly coupled to the sump housing to allow for the electrolyte to be fed from the sump housing into the cell housing, and
wherein the sump comprises a maximum fill line corresponding to an uppermost portion of the wick of the stack.
